(19) United States
(12) Patent Application Publication
(10) Pub. No.: US 2010/0030468 A1
(43) Pub. Date: Feb. 4, 2010

(54) METHOD OF GENERATING NAVIGATION MESSAGE AND SYSTEM THEREOF

(75) Inventor: Ping Zou, Shanghai (CN)

Correspondence Address: WPAT, PC;INTELLECTUAL PROPERTY ATTORNEYS, 2030 MAIN STREET, SUITE 1300, IRVINE, CA, 92614, US

(73) Assignees: Mitac International Corp., Taoyuan (TW); Mitac Research (Shanghai) Ltd., Shanghai (CN)

(21) Appl. No.: 12/396,655

(22) Filed: Mar. 3, 2009

(30) Foreign Application Priority Data
Aug. 4, 2008 (TW) 097129584

(51) Int. Cl. G01C 21/36

(52) U.S. Cl. 701/209

(57) ABSTRACT

The present invention discloses a method of generating navigation message and navigation system thereof, which are characterized in that, during navigation, the navigation messages used to remind users comprise landmark points located about a road turn and providing significantly recognizable characters or marks, allowing users to more conveniently determine the road turn so as to avoid taking wrong route. Furthermore, users are also enabled to set landmark point type, priority or name that users are able to recognize, further creating customized navigation messages.

### BACKGROUND OF THE INVENTION

1. Field of the Invention

The present invention is related to a navigation system, and more particularly to a method and system of generating navigation message containing navigation messages having information of significant landmark point.

2. Description of Related Art

As technologies employed in satellite navigation system are increasingly well developed and fabrication cost drops down, satellite navigation system has now become one of the required electronic outfits for car drivers. Satellite navigation system estimates its own longitude/latitude information through receptions of at least four satellite signals, and compares such longitude/latitude information with electrical map to acquire the information about the place where the device is presently located. Next, satellite navigation system performs routing function and navigation function to guide the user to reach the preset destination by means of navigation messages. However, in a conventional navigation system, it is common to use a fixed guiding name to remind user. For example, “Drive in right lane 500 meters ahead” or “Turn right at cross-road in front”. The so-called “cross-road in front” may be an object uneasy to be seen for driver, especially when there are vehicles driving ahead, in which case it is difficult to allow drivers to make sure which objective is referred by such a “cross-road in front”, and the result causes that the driver tend to miss the cross-road where they need to turn and re-routing is then required, ad it reduces undesirably the effect of navigation system. The aforementioned situations are even more significant in a metropolitan with high density of roads and highways.

### SUMMARY OF THE INVENTION

Therefore, one of the objectives of the present invention is to provide a method of generating navigation message and navigation system thereof, so as to improve the recognition of navigation messages.

To achieve the abovementioned objective, at least embodiment of the present invention discloses a method of generating navigation message comprising the following steps. First, an electrical map containing a plurality of road data and a plurality of landmark points is provided, and a guiding route containing at least one guiding point is provided. The current position of user is provided. The oncoming guiding point for reminding the user is determined according to the current position of user and the guiding route, and then the landmark point corresponding to the determined guiding point is selected from the electrical map, and a navigation message containing information about the selected landmark point is generated.

Preferably, the landmark points comprise buildings of significantly recognizable characters or marks, such as chain stores, schools, post offices, banks, police stations or any other famous constructions.

Preferably, the method further comprises a step of providing landmark point parameters used to generate the navigation message, and selecting landmark point according to such landmark point parameters.

Besides, at least embodiment of the present invention further discloses a navigation system comprising an electrical map database, a positioning module, a display module, a routing module and a navigation module. The electrical map stores at least one electrical map containing a plurality of road data and a plurality of landmark points. The positioning module is capable of providing the current position of user. The display module is capable of displaying the electrical map corresponding to the current position of user. The routing module is capable of calculating a guiding route from a start to a destination according to the electrical map, and guiding route contains at least one guide point. The navigation module then determines the oncoming guiding for reminding the user according to the current position of user and the guiding route, and selects the landmark point corresponding to the determined guiding point from the electrical map, and then generates a navigation message containing information about the selected landmark point.

Preferably, the landmark points comprise buildings of significantly recognizable characters or marks, such as chain stores, schools, post offices, banks, police stations or any other famous constructions.

Preferably, the navigation system further comprises a landmark point set interface capable of allowing the user to set landmark point parameters used to generate the navigation message, and such landmark point parameters comprise landmark point type, priority or name.

The method of generating navigation message, and navigation system thereof according to the present invention have at least one of the following advantages:

(1) the generated navigation messages can comprise landmark point conveniently recognized by users, so that the situations of missing erroneously the guiding point by users and re-routed can be prevent.

(2) users are allowed to set by themselves the landmark point parameters for generating navigation message, such that the navigation messages can contain the landmark points that users are familiar with; in this way, it is possible to allow travelers utilizing the navigation system according to the present invention abroad to set recognizable landmark points, such as well-known global fast food chain stores, to improve recognition of the navigation messages.

### BRIEF DESCRIPTION OF THE DRAWINGS

The exemplary embodiment(s) of the present invention will be understood more fully from the detailed description given below and from the accompanying drawings of various embodiments of the present invention, which, however, should not be taken to limit the invention to the specific embodiments, but are for explanation and understanding only.

FIG. 1 is a block diagram of a first embodiment of the navigation system according to the present invention;

FIG. 2 is a diagram of an exemplary screen shot of the navigation system according to the present invention;

FIG. 3 is a block diagram of a second embodiment of the navigation system according to the present invention;

FIG. 4 is a diagram of an exemplary landmark point set interface of the navigation system according to the present invention; and

FIG. 5 is a step-wise flowchart of an embodiment of the method for navigation message generation according to the present invention.

### DETAILED DESCRIPTION OF THE PREFERRED EMBODIMENTS

Exemplary embodiments of the present invention are described herein in the context of a method of generating navigation message and navigation system thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

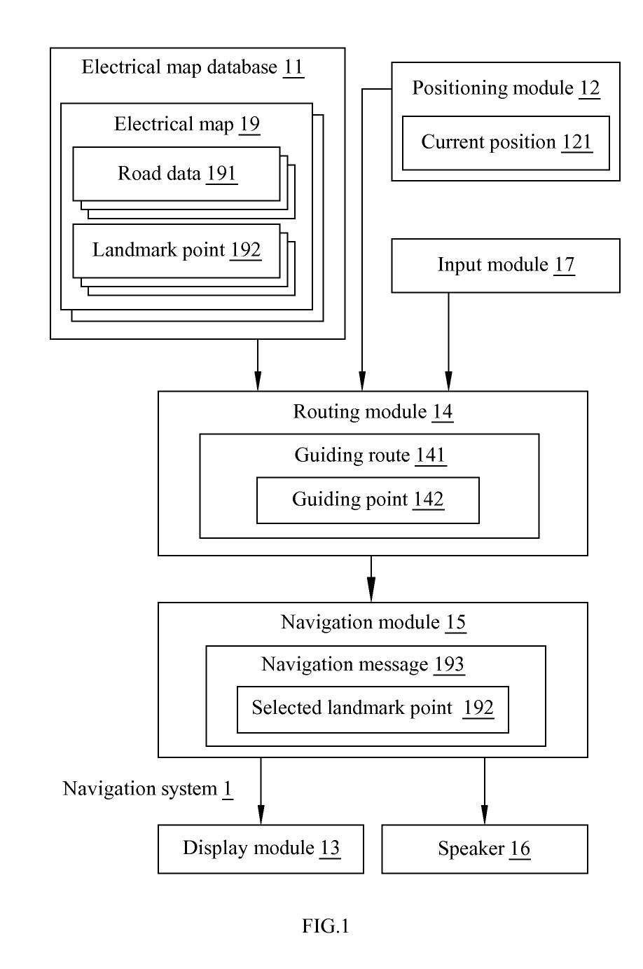

FIG. 1 illustrates a block diagram of a first embodiment of the navigation system according to the present invention. The navigation system 1 comprises an electrical map database 11, a positioning module 12, a display module 13, a routing module 14, a navigation module 15, a speaker 16 and an input module 17. The electrical map database 11 stores at least one electrical map 19, and electrical map 19 containing at least a plurality of road data 191 and a plurality of landmark points 192, and the road data 191 including road shapes, road names, cross-roads, attributes, two-dimensional coordinates or other data. Preferably, the landmark points 192 contain buildings of significantly recognizable characters or marks, such as chain stores, schools, post offices, banks, police stations or any other famous constructions. Preferably, the electrical map database 11 can be a hard drive, an optical storage media (DVD or CD), a memory card or other storage media having the same or similar features.

The positioning module 12 is capable of providing the current position of user 121, and can be a Global Positioning System (GPS) module, a gyroscope or an accelerometer preferably. The input module 17 allows the user to perform data input and function selections. The input module 17 can be preferably a touch panel, a remote controller, a keyboard or a mouse. User also can input or select the desired destination or start position via the user input interface.

The routing module 14 calculates a guiding route 141 from the start to the destination according to the start, destination and the electrical map 19. If the user does not input or select the start, then the current position of user 121 is taken as the start. The guiding route 141 comprises at least a guiding point 142, which is mostly a road turn, a cross-road, a bridge entry or some straying location and so forth; hence, as determining that the user is approaching to a certain guiding point 142, it needs to remind the user. The aforementioned acquisition methods for current position of user and guiding route are well-known in the art, herein further descriptions thereof are omitted for clarity of the present disclosure.

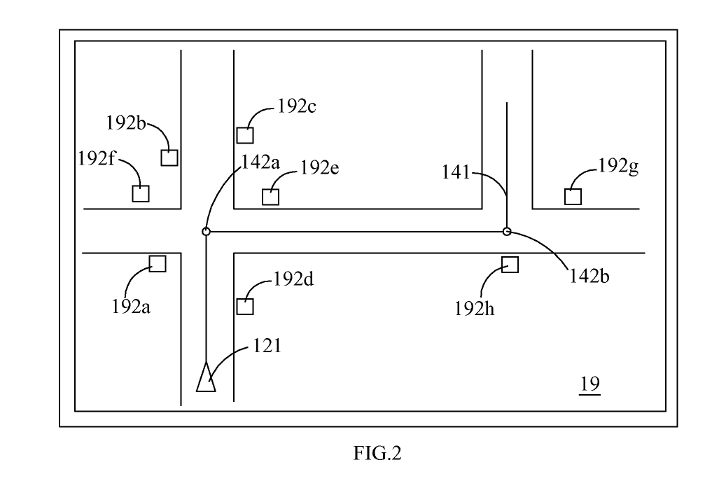

The navigation module 15 acquires an electrical map 19 corresponding guiding to route 141 from the electrical map database 11, and drives the display module 13 to display such electrical map 19. FIG. 2 illustrates a schematic view of an exemplary screen shot of the navigation system according to the present invention. In the electrical map 19, the guiding route 141 contains two guiding points 142a and 142b. In general, guiding points are mostly defined at the central positions of cross-roads. Landmark points 192a to 192e are located about the guiding point 142a, and landmark points 192f to 192g are located about the guiding point 142b.

The navigation module 15 determines the oncoming guiding point 142 for reminding the user according to the current position of user 121 and the guiding route 141. Preferably, the navigation module 15 can determine in several approaches, in which the first way is to respectively calculate the distance between each guiding point 142 and the current position of user 121, and use the guiding point 142 closest to the current position of user 121 as the guiding point 142 intended to remind the user; or, in a second way, the guiding route 141 has order list of roads for guiding users, and the navigation module 15 determines the guiding point 142 intended to remind the user according to such an order list. The above determination methods are simply exemplary, rather than being limited thereto; such determination methods are well-known for those skilled ones in the art, herein only two examples are illustrated and further descriptions are omitted for clarity of the present disclosure.

After determining the guiding point 142 intended to remind the user, for example, the guiding point 142a in FIG. 2, the navigation module 15 acquires nearby landmark points near the guiding point 142a, such as landmark points 192a˜192f, from the corresponding electrical map 19, and then selects the landmark corresponding to such guiding point 142 for reminding the user according to a preset condition. Preferably, the preset condition can comprise the following one:

(i) to select the landmark point closest to the guiding point; e.g. landmark point 192a;

(ii) to select the landmark point located at the drive way along which the user is currently advancing, such as selecting from landmark points 192d and 192c. Although selection of landmark point closest to the guiding point may allow the user most directly recognize the guiding point, it is possible that the closest one is not located along the drive lane of the user, and the user is unable to see it, e.g. landmark point 192a;

(iii) to select the landmark points located behind the guiding point, e.g. landmark points 192b and 192c, for facilitating the user to observe the guiding point;

(iv) to select the landmark points located on the direction the user should turn to; for example, if the user should turn right at the guiding point 142a, then landmark point 192e should be selected; in case the user should turn left at the guiding point 142a, then landmark point 192f is the choice.

The preferred conditions illustrated above may be also employed in combination. For example, the conditions (i) and (iii) may be conjunctively used, thus selecting the landmark point 192b for reminding; or, the conditions (i) and (ii) may be conjunctively used, thus selecting the landmark point 192c for reminding. The above-described conditions are simply exemplary, rather than being limited thereto.

According to the current position of user, the position of selected landmark point and the position of the guiding point, the navigation module 15 calculates the guiding distance and generates a navigation message 193 containing the information about the selected landmark point, guiding distance and guiding direction to remind the user. For example, if the selected landmark point is “xx Fast Food Store”, the generated navigation message 193 is “Turn right at xx Fast Food Store 200 meters ahead”; or if the selected landmark point is “post office”, the generated navigation message 193 is “Turn left at the post office 50 meters in front”. In the navigation message 193, the guiding distance can be differently expressed according to differing locations of the landmark points, and the above-mentioned examples are simply illustrative, rather than being limited thereto. Since such landmarks are buildings having significantly recognizable characters or marks, such as chain stores, schools, post offices, banks, police stations or famous constructions, as result, even there are other vehicle driving or stopping ahead, the drive can still easily see them to make a turn at correct guiding point. The navigation message 193 can be presented on the display module 13 or through the speaker 16.

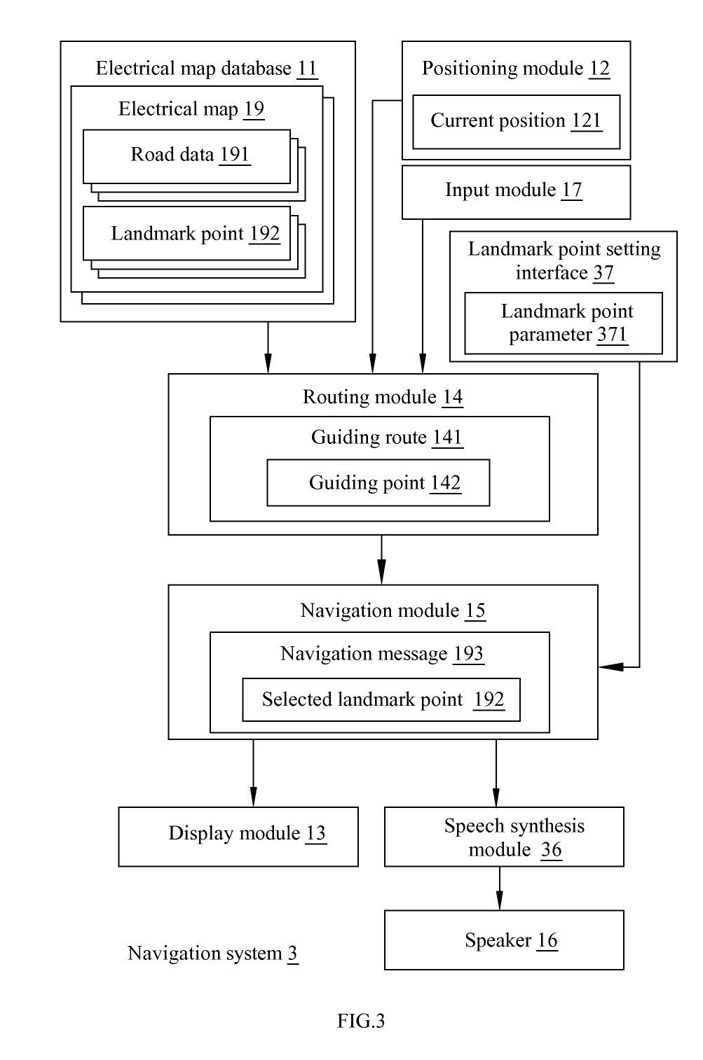

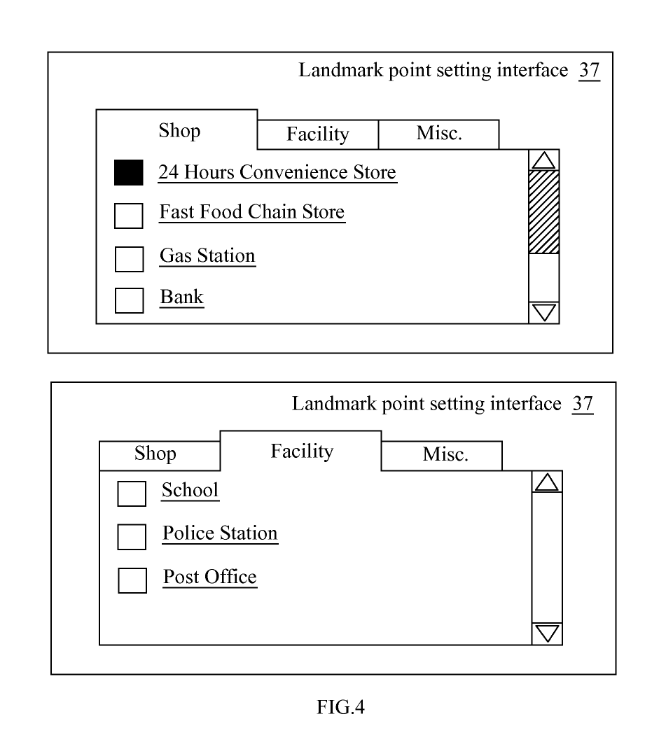

FIG. 3 illustrates a block diagram of a second embodiment of the navigation system according to the present invention. The differences between the second embodiment and the first embodiment are in that the navigation system 3 comprises a landmark point setting interface 37 and a speech synthesis module 36. The landmark point setting interface 37 is capable of allowing the user to set the landmark point parameters 371 for the generation of the navigation message 193, such as landmark point type, priority or name, as shown in FIG. 4. In particular, when the user arrives at an unfamiliar location, e.g. an area in some foreign country, it is possible that the user has no idea about features or marks indicating local post office, police station or shopping store. Therefore, the landmark point setting interface 37 allows the user to set the landmark points he/she can recognize, such as setting globally known fast food chain store whose mark is consistent worldwide, and the navigation module 15 selects at high priority the landmark matching with the landmark point parameters 371 set by the user as the message for reminding. In case nearby the guiding point there is no landmark matching with the landmark point parameters 371 set by the user, the navigation module 15 then uses other landmarks or directly the guiding point as the message for reminding. Additionally, by setting the landmark point parameters 371 via the landmark point setting interface 37, the navigation system can be more customized.

The speech synthesis module 36 is capable of synthesizing the speech voice in real-time, which contains the name of the selected landmark point, guiding distance and guiding direction, and is outputted through the speaker 16. In addition to position indication, the electrical map shown on the display module 13 can also display significantly recognizable characters or marks of such landmark points 192, thus facilitating user's recognition.

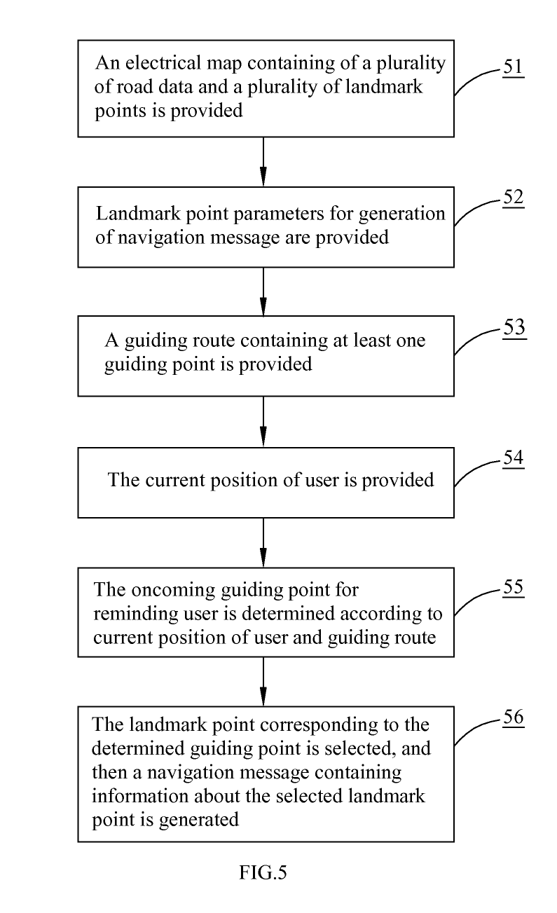

FIG. 5 illustrates a flowchart of an embodiment of the method of generating navigation message according to the present invention. The method comprises the following steps. In Step 51, an electrical map containing of a plurality of road data and a plurality of landmark points is provided. Preferably, so-called landmark points includes buildings of significantly recognizable characters or marks, such as chain stores, schools, post offices, banks, police stations or any other famous constructions. In Step 52, landmark point parameters for generation of navigation message are provided. For example, the user can set landmark point parameters via a landmark point set interface, as shown in FIG. 4. In Step 53, a guiding route containing at least one guiding point is provided, and the guiding point is referred to the position at which the user needs to change his/her driving direction. Subsequently, in Step 54, the current position of user is provided, for example, the longitude/latitude data of user's position can be generated by a GPS system.

In Step 55, according to the current position of user and the guiding route, the oncoming guiding point for reminding the user is determined, such as the guiding point closest in terms of distance, or determined in accordance with order of guiding points appearing along the guiding route. Next, in step 56 the landmark point corresponding to the determined guiding point for reminding the user is selected from the electrical map, and then a navigation message containing information about the selected landmark point is generated, e.g. “Turn right at xx Fast Food Store 200 meters ahead” or “Turn left at the post office 50 meters in front”. Such navigation message allows the user to more conveniently recognize the guiding point, so the possibility of missing such a guiding point can be reduced. Furthermore, there is landmark point name friendly to the user are employed in the navigation message, rather than terms like “joint of roads”, and it can make the user feel more enjoyable.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A method of generating navigation message, comprising the steps of:
providing an electrical map containing a plurality of road data and a plurality of landmark points;
providing a guiding route containing at least one guiding point;
providing a current position of user;
determining the oncoming guiding point for reminding the user according to the current position of the user and the guiding route; and
selecting the landmark point corresponding to the determined guiding point from the electrical map, and generating a navigation message containing information about the selected landmark point.

2. The method of claim 1, wherein the landmark points comprise buildings having significantly recognizable characters or marks.

3. The method of claim 2, further comprising a step of:
displaying the significantly recognizable characters or marks of the landmark points on the electrical map.

4. The method of claim 1, wherein the selected landmark point is the landmark point closest to the guiding point.

5. The method of claim 1, further comprising a step of:
providing landmark point parameters used to generate the navigation message, and performing selection of landmark points according to the landmark point parameters.

6. The method of claim 5, wherein the landmark point parameters comprise landmark point type, priority or name.

7. The method of claim 1, wherein the navigation message contains information about the selected landmark point, a guiding distance and a guiding direction.

8. A navigation system, comprising:
an electrical map database storing at least one electrical map, and the electrical map containing a plurality of road data and a plurality of landmark points;
a positioning module capable of providing the current position of user;
a display module capable of displaying the electrical map corresponding to the current position of user;
a routing module capable of calculating a guiding route from a start to a destination according to the electrical map, and the guiding route containing at least one guide point; and
a navigation module capable of determining oncoming guiding point for reminding the user according to the current position of the user and the guiding route, and selecting the landmark point corresponding to the determined guiding point from the electrical map, and then generating a navigation message containing information about the selected landmark point.

9. The navigation system of claim 8, wherein the landmark points comprise buildings having significantly recognizable characters or marks.

10. The navigation system of claim 9, wherein the display module displays the significantly recognizable characters or marks of the landmark points on the electrical map.

11. The navigation system of claim 8, wherein the selected landmark point is the landmark point closest to the guiding point.

12. The navigation system of claim 8, further comprising a landmark point setting interface capable of allowing users to set landmark point parameters used to generate the navigation message, wherein landmark point parameters comprise landmark point type, priority or name.

13. The navigation system of claim 12, wherein the navigation module performs selection of landmark points according to the landmark point parameters set by the user.

14. The navigation system of claim 8, wherein the navigation message comprises information about the selected landmark point, a guiding distance and a guiding direction.
